(19) United States
(12) Patent Application Publication
(10) Pub. No.: US 2019/0097842 A1
(43) Pub. Date: Mar. 28, 2019

(54) IPv4 Gateway

(71) Applicant: Silicon Laboratories Inc., Austin, TX (US)

(72) Inventors: DeWitt Clinton Seward, Arlington, MA (US); Greg Hodgson, Austin, TX (US); Clay Daigle, Austin, TX (US); Preston Fick, Austin, TX (US); John Hemmick, Austin, TX (US)

(21) Appl. No.: 15/716,999

(22) Filed: Sep. 27, 2017

(51) Int. Cl. H04L 12/66; H04W 84/02; H04W 84/10

(52) U.S. Cl. CPC H04L 12/66; H04L 2012/5618; H04W 84/10; H04W 84/02

(57) ABSTRACT

A system and method for allowing legacy devices to operate on an IPv4 network is disclosed. The system includes a gateway device to interface between IPv4 devices and legacy devices. In some embodiments, the gateway device has a plurality of network interfaces to communicate with these legacy devices. The gateway device discovers the legacy devices that it can communicate with. The gateway device then enumerates these legacy devices in a manner that allows them to be accessible to the IPv4 device. In certain embodiments, the gateway enumerates each legacy device as a port on its IPv4 address.

### BACKGROUND

The explosion of network connected devices has led to an increased use of certain protocols. ZigBee Cluster Library over IP (ZCLIP), also referred to as DotDot, is a new standard intended to improve the security and universal connectivity of the Internet of Things (IoT). As the adoption of DotDot continues to grow, there will be an entire set of infrastructure developed to allow communication between DotDot devices and the cloud, which includes PCs, smart phones, cloud servers and other devices. DotDot is an application layer which may be utilized with different network layers. One such network layer is known as Internet Protocol (IP). Further, there are two versions of Internet Protocol; version 4 (IPv4) and version 6 (IPv6).

However, there are already millions of devices that communicate wirelessly using other protocols, such as ZigBee®, BlueTooth, BLE and others. For example, ZIGBEE® is now commonly used in many applications, including utility meters, lighting systems and the like.

There is a need to find a way in which the currently existing devices, which do not utilize the DotDot protocol, can be included as part of an existing network. Obviously, retrofitting all of these existing devices with new software and possibly new hardware is not feasible for many reasons.

Therefore, there needs to be a system and method that allows these legacy devices to operate on a DotDot network using IPv4, without requiring any changes to these legacy devices. However, there are now security requirements associated with the DotDot protocol that complicate this objective. Consequently, it would be beneficial to have a system and method that allows legacy devices to operate on a DotDot network without compromising the security of the DotDot network.

### SUMMARY

A system and method for allowing legacy devices to operate on a DotDot network using IPv4 is disclosed. The system includes a gateway device to interface between DotDot devices and legacy devices. In some embodiments, the gateway device has a plurality of network interfaces to communicate with these legacy devices. The gateway device discovers the legacy devices that it can communicate with. The gateway device then enumerates these legacy devices in a manner that allows them to be accessible to the DotDot device. In certain embodiments, the gateway device enumerates each legacy device as a port on its IPv4 address.

According to one embodiment, a gateway device is disclosed. The gateway device comprises an IPv4 network interface; a secondary network interface; a processing unit and a memory device, where the memory device comprises instructions, which when executed by the processing unit, allow the gateway device to: receive a message from an IPv4 device using the IPv4 network interface; translate the message to a legacy format; and transmit the translated message using the secondary network interface to a legacy device. In certain embodiments, the secondary network interface supports an IEEE 802.15.4 network protocol or a BLUETOOTH® network protocol. In certain further embodiments, the memory device further comprises instructions, which when executed by the processing unit, allow the gateway device to: communicate with legacy devices using the secondary network interface; query each legacy device to understand functionality of each legacy device; enumerate each function as a port in its IPv4 address; and create an internal mapping between port designation and each legacy device or function.

According to another embodiment, a method of configuring a legacy device to operate on an IPv4 network is disclosed. The method comprises using a gateway device to communicate to the legacy device using a secondary network interface; enumerating the legacy device as a port number on the IPv4 address of the gateway device; and establishing a connection with an IPv4 device where the source address comprises the IPv4 address of the gateway device and the port number. In some embodiments, the gateway device creates an internal mapping associating the port number with the legacy device. In some embodiments, the method further comprises querying the legacy device to understand functionality of the legacy device; and wherein each function of the legacy device is assigned a unique port number. In some embodiments, the method further comprises configuring a second legacy device to operate on the IPv4 network by: using a gateway device to communicate to the second legacy device using a second secondary network interface; and assigning the second legacy device a second unique port number. In certain embodiments, the IPv4 network is a DotDot network.

According to another embodiment, a gateway device is disclosed. The gateway device comprises an IPv4 network interface; a secondary network interface; a processing unit and a memory device, where the memory device comprises instructions, which when executed by the processing unit, allow the gateway device to: communicate with a legacy device using the secondary network interface; initiate a connection to a IPv4 device via the IPv4 network interface on behalf of the legacy device, wherein the source address used for the connection comprises a IPv4 address of the gateway device and a port number assigned to the legacy device by the gateway device. In some embodiments, the memory device further comprises instructions, which when executed by the processing unit, allow the gateway device to: query the legacy device to understand functionality of each the device; and enumerate each function of the legacy as a port in the IPv4 address of the gateway device. In certain embodiments, the memory device further comprises instructions, which when executed by the processing unit, allow the gateway device to: communicate with additional legacy devices using the secondary network interface; and enumerate each legacy device as a port in the IPv4 address of the gateway device. In some embodiments, the the gateway device comprises a second secondary network interface, and the memory device further comprises instructions, which when executed by the processing unit, allow the gateway device to: communicate with legacy devices using the second secondary network interface; and enumerate each legacy device as a port in the IPv4 address of the gateway device.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a gateway device according to one embodiment;

FIG. 2 shows the gateway device of FIG. 1 in one implementation;

FIG. 3 illustrates a flowchart showing the initialization of the gateway device according to one embodiment; and

FIG. 4 illustrates a flowchart showing the operation of the gateway device according to one embodiment.

### DETAILED DESCRIPTION

As described above, DotDot is an emerging network protocol that allows communication over IP. While intended for wireless communications to support the Internet of Things (IoT), it is also usable over wired connections. The DotDot specification describes a generic application layer which can be used with different network stacks. For example, Thread is actively working on a network stack that is compatible with DotDot. DotDot defines an application layer. This application layer is similar to that already defined by the ZIGBEE® protocol. Stated differently, DotDot does not mandate a particular physical interface, but does mandate a specific application layer. In all embodiments, DotDot utilizes a network layer that relies on the Internet Protocol (IP). This network layer may be Internet Protocol version 4 (IPv4) or Internet Protocol version 6 (IPv6). IPv4 protocol is pervasive throughout the world, where there are billions of devices that are capable of communicating using this protocol. IPv4 is a network layer protocol which is used to route most Internet traffic today. One drawback of IPv4 is that is can only support 2³² (about 4 billion) unique addresses. This limit is rapidly being reached, prompting efforts to migrate to IPv6, which supports a virtually unlimited number of addresses (the actual number of addresses is 2¹²⁸). While new protocols that utilize IPv6 are being pursued, currently, the number of devices that support IPv6 is a fraction of those that support IPv4. Consequently, there is a need, at least in the short term, to be able to support communications between IPv4 devices and other network protocols, such as ZigBee®, Bluetooth®, BLE, and others.

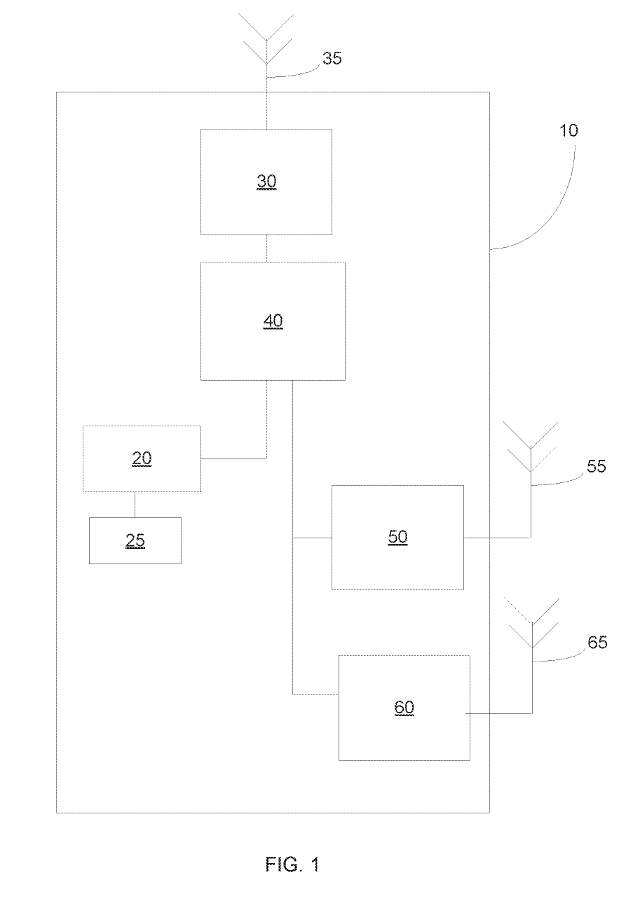

FIG. 1 shows a block diagram of a representative gateway device 10. The gateway device 10 has a processing unit 20 and an associated memory device 25. This memory device 25 contains the instructions, which, when executed by the processing unit 20, enable the gateway device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

The gateway device 10 also includes an IPv4 network interface 30, which may be a wireless interface including an antenna 35. As stated above, IPv4 defines a network layer. Therefore, the IPv4 network interface 30 may be any interface that supports the IPv4 protocol. For example, in certain embodiments, the IPv4 network interface 30 may be an ethernet network controller. In other embodiments, the IPv4 network interface 30 may be a WIFI network controller. Further, the IPv4 network may be used to support any application layer, such as TCP, UDP or DotDot. Thus, while the disclosure describes the gateway device with respect to DotDot, it is understood that the gateway device may be used to communicate with any application layer that utilizes IPv4.

In this disclosure, the IPv4 network interface 30 may be referred to as the primary network interface, while all other network interfaces are referred to as secondary network interfaces. Further, throughout this disclosure, the term “legacy device” is used to denote any device that does not use the IPv4 protocol.

The gateway device 10 may include a second memory device 40 in which data that is received by the IPv4 network interface 30, and data that is to be transmitted by the IPv4 network interface 30, is stored. This second memory device 40 is traditionally a volatile memory. The processing unit 20 has the ability to read and write the second memory device 40 so as to communicate with the other nodes in the network. Although not shown, the gateway device 10 also has a power supply, which may be a battery or a connection to a permanent power source, such as a wall outlet.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language and is not limited by this disclosure. Thus, in some embodiments, there may be multiple computer readable media that contain the instructions described herein. The first computer readable media may be in communication with the processing unit 20, as shown in FIG. 1. The second computer readable media may be a CDROM, or a different memory device, which is located remote from the gateway device 10. The instructions contained on this second computer readable media may be downloaded onto the memory device 25 to allow execution of the instructions by the gateway device 10.

The gateway device 10 may also include a second network interface 50. This second network interface 50 may support any wireless network, including ZIGBEE®, Thread, BLUETOOTH®, BLE, a cellular protocol, such as 3G, GCM, CDMA, 4G, LTE, or other protocols. The second network interface 50 may include a second antenna 55.

In certain embodiments, the gateway device 10 may include a third network interface 60 with a third antenna 65. For example, the second network interface 50 may support ZigBee® and the third network interface 60 may support another wireless protocol, such as BLE or BLUETOOTH®. In fact, an arbitrary number of secondary network interfaces may be disposed on the gateway device 10. For example, there may be a plurality of secondary network interfaces to support ZigBee®, BLUETOOTH®, Thread, BLE and others.

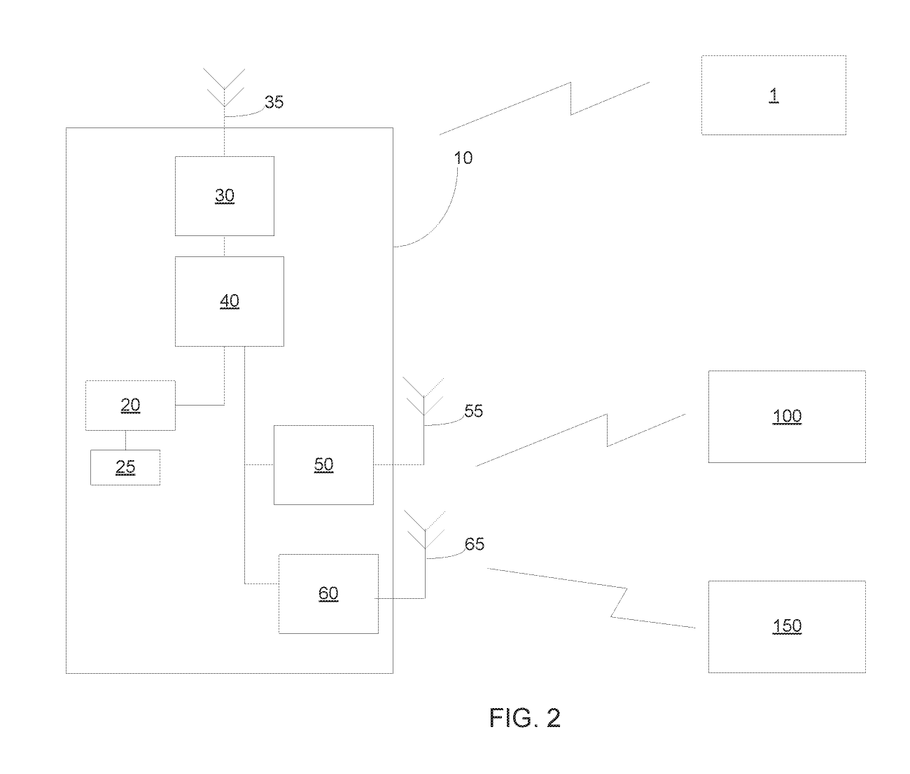

FIG. 2 shows the gateway device 10 in communication with a ZIGBEE® device 100. The gateway device 10 uses the existing ZIGBEE® standard to communicate with the ZIGBEE® device 100. As is well known, ZIGBEE® operates using the standard defined in IEEE 802.15.4. In other words, the IEEE 802.15.4 specification defines the physical and media access control layers of the network. The ZIGBEE® standard defines the higher level network protocols. The ZIGBEE® device 100 may be an end device or a sleepy device. The gateway device 10 serves as the parent node on the ZIBGBEE® network. The gateway device 10 may be a coordinator device or a router device. The second network interface 50 of the gateway device 10 provides the hardware support to communicate to the ZIGBEE® device 100.

FIG. 2 also shows the gateway device 10 in communication with a second network device 150. In certain embodiments, the third network interface 60 is used to communicate with the second network device 150. This second network device 150 may communicate using the BLUETOOTH® or BLUETOOTH® Low Energy (BLE) protocol, for example. In other embodiments, this second network device 150 may communicate using a different protocol, such as another protocol based on IEEE 802.15.4, such as Thread. In still other embodiments, the second network device 150 may not be present. In other embodiments, the ZIGBEE® device 100 is not present, and only the third network interface 60 is used. Further, the number of secondary network interfaces that may be disposed on the gateway device 10 is not limited by this disclosure. In other words, although the present disclosure describes a first network interface to communicate using the DotDot protocol with IPv4 and two secondary network interfaces, any number of secondary network interfaces may be employed. Further, the number of devices that communicate with the gateway device 10 is not limited by this disclosure.

In certain embodiments, network protocols that utilize the same physical layer, such as ZIGBEE® and Thread, which both utilize the physical and media access control layers defined in IEEE 802.15.4, may be accessed using the same secondary network interface. In other embodiments, separate secondary network interfaces may be used for different protocols.

Finally, FIG. 2 shows the gateway device 10 in communication with another IPv4 device 1. The gateway device 10 communicates with the IPv4 device 1 using the IPv4 network interface 30. This IPv4 device 1 may be a DotDot device. As described above, the IPv4 network interface 30 may be WIFI, Ethernet or another other communication mechanism that utilizes the IP protocol. Further, as described above, the application layer may be DotDot, although other protocols may also be used.

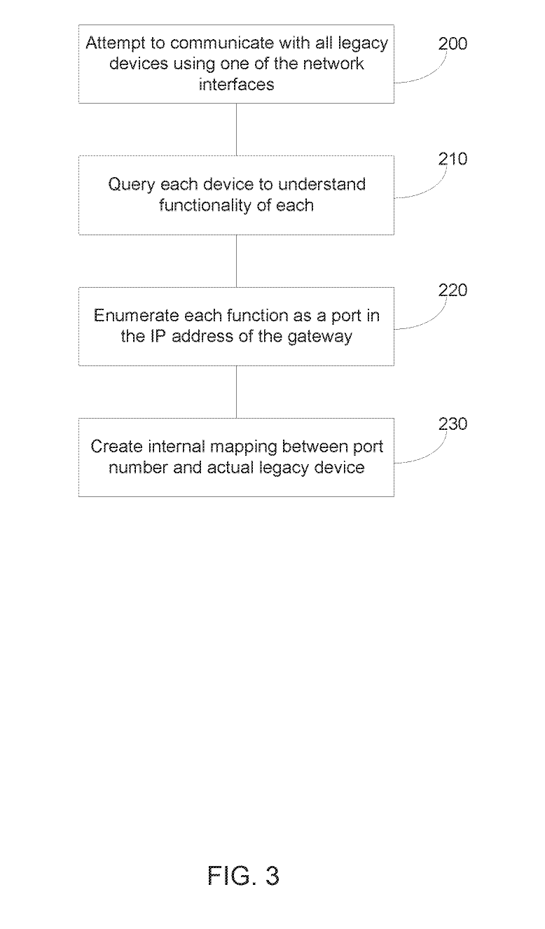

FIG. 3 shows a representative flowchart showing the initialization of the gateway device 10. In operation, the gateway device 10 uses a secondary network interface, such as the second network interface 50, to attempt to communicate with legacy devices, such as the ZIGBEE® device 100 and any other ZIGBEE® devices within its listening range, as shown in Box 200. Once the gateway device 10 has enumerated all of the ZIGBEE® devices, it then queries each device to understand its functionality, as shown in Box 210. For example, some ZIGBEE® devices may be sensors, others may be lighting devices, others may be switching devices to control the lighting devices. In certain embodiments, a ZIGBEE® device may have more than one function. For example, a ZIGBEE® device may be a combination occupancy sensor and thermostat device. Once the gateway device 10 has fully enumerated all of the devices in communication with the second network interface 50, and queried each device to understand its functions, it designates each of these functions as a port of the IP address used by the gateway device 10, as shown in Box 220. In other embodiments, ports may be assigned per device rather than per function.

The gateway device 10 also maintains an internal mapping between the port designation and the address of the ZIGBEE® device associated with that port number, as shown in Box 230. This internal mapping may include an indication of the protocol used by the legacy device associated with the port number (or the network interface to be used to connect to the ZIGBEE® device associated with that port number), the address of the ZIGBEE® device associated with that port, and other parameters. In this way, when a IPv4 device accesses a port of the gateway device 10, the gateway device 10 is able to determine which external legacy device is associated with that port number. In some embodiments, because ports may be assigned to separate functions, this mapping may not be a 1:1 mapping. Rather, multiple port numbers may correspond to a single legacy device that includes multiple functions. In other embodiments, each device is assigned a single port number, so the internal mapping represents a 1:1 mapping between port number and legacy device.

This process is then repeated for each network interface disposed on the gateway device 10. Thus, if there is a third network interface 60, this sequence is repeated to identify all devices in communication with the third network interface 60. Further, if there are additional secondary network interfaces disposed on the gateway device 10, the process illustrated in FIG. 3 would be performed for each of those network interfaces.

Once the gateway device 10 has completed the initialization process shown in FIG. 3 for all of the network interfaces, it is able to establish connections between the legacy devices and a remote IPv4 device, such as a mobile device, a cloud-based server, or any other gateway that presents itself as a IPv4 device. In certain embodiments, the remote IPv4 device may communicate using the DotDot application layer.

Once the gateway device 10 has been configured, it is able to be deployed in the IPv4 network, such as a DotDot network. Advantageously, it also allows the operation of existing wireless devices that do not utilize IPv4 protocol.

For example, assume that the gateway device 10 determines that it is connected to 8 other devices. These devices may include a combination of legacy devices, such as ZIGBEE® devices, BLE devices, BLUETOOTH® devices, Thread devices and the like. These devices may also include functions that are internal to the gateway device 10. As an example, the devices may be defined as follows:

| Port Number | Function/Device |
|---|---|
| 5700 | Legacy ZigBee device #1 -light bulb |
| 5701 | Legacy ZigBee device #2 -light bulb |
| 5702 | Legacy ZigBee device #3 -light bulb |
| 5703 | Legacy ZigBee device #4 - switch |
| 5704 | Legacy ZigBee device #5 - occupancy sensor |
| 5705 | Legacy ZigBee device #5 - thermostat |
| 5706 | Legacy BLE device - smart sensor |
| 5707 | DotDot device - running Thread protocol |
| 5708 | Internal Function - network management |

Having enumerating all of the devices that are in communication with the gateway device 10, the gateway device 10 can then assign each device or function a unique port number. This information is made available to other IPv4 devices by means typically used in IPv4 communications.

While providing address translation through the use of port numbers, the present system is very different than traditional NAT (network address translation) and Port Forwarding. Specifically, in traditional NAT and Port Forwarding environments, the devices on both sides of the gateway or router are native IP devices. In other words, these devices operate using the IP protocol. The only function performed by the gateway or router is the conversion of a private IP address to a public IP address. This is done by simply replacing the private IP address of the hidden device with a public IP address and a specified port number. In other words, the hidden device, which has the private IP address, communicates with the public IPv4 device using native protocols. There is no conversion or translation required by the gateway or router (except for address translation).

For example, traditionally, the hidden device seeks to establish a connection with the public IPv4 device. As an illustrative example, assume that a hidden device wishes to access a website. This hidden device is disposed on a private network on one side of a gateway or router. The website is disposed on a public network located on the other side of the gateway or router. The hidden device first seeks to establish a connection with the webserver, using the public IP address of the webserver. It sends this message over its IP connection, which may be wired or wireless, onto the private IP network. This message uses the public IP of the webserver as the destination address and the private IP address of the hidden device as the source address. This message is received by the gateway or router. If this is the first message from this hidden device, the gateway or router assigns it a unique port number. If this is a subsequent message, the gateway or router uses the same port number that was previously established. The gateway or router then replaces the source address in the packet with a new source address. This new source address contains the public IP address of the gateway or router, with the unique port number. This new address represents the publicly known IP address for the hidden device, and allows the gateway to properly direct incoming traffic back to this hidden device.

The gateway or router then forwards this modified message, where it is routed to the webserver over the public IP network. The webserver responds to this message by sending a second message. This second message includes the webserver public IP address as the source address and the publicly available IP address of the hidden device as the destination address. This message is routed to the gateway or router, since this device uses the IP address contained in the destination address. The gateway or router then replaces the destination address and port number with the private IP address of the hidden device. In addition, the gateway or router recalculates the checksum for the header. The gateway or router then forwards the message on its private IP network to the hidden device.

Finally, if the hidden device on the private network stops communicating with the website, the port mapping will likely be timed out by the gateway so that the port can be re-used.

Thus, the gateway or router only manipulates messages that are already being transmitted between the two IP devices. In contrast, the gateway device 10 of the present disclosure must perform many more functions.

First, legacy devices typically do not initiate the connection to a server or other remote device. Rather, most legacy devices wait for a master or parent node to send a message to them. Therefore, unlike conventional gateways, the gateway device 10 of the present disclosure must initiate the connection to any public devices.

Second, the gateway or router must assign port numbers differently than in traditional embodiments. Specifically, as described above, the traditional gateway assigns the unique port number when the hidden device attempts to establish a connection to a public IPv4 device. In the present embodiment, the gateway device 10 must assign the port number before any messages are transmitted. This is because, as described above, the legacy device does not initiate a connection. Therefore, the gateway device 10 must initiate the connection and must assign the unique port number before it can send the message to the public IPv4 device.

Third, as stated above, the legacy devices do not utilize the IP protocol. Thus, the present gateway device 10 requires much more functionality than conventional NAT and Port Forwarding routers. For example, it needs its own mechanism to determine the public IP address with which legacy devices will communicate.

Fourth, the ports assigned to the legacy devices will remain active independently of the communication activity. There can be no time out of this port mapping or the legacy device would lose its connection to the outside world.

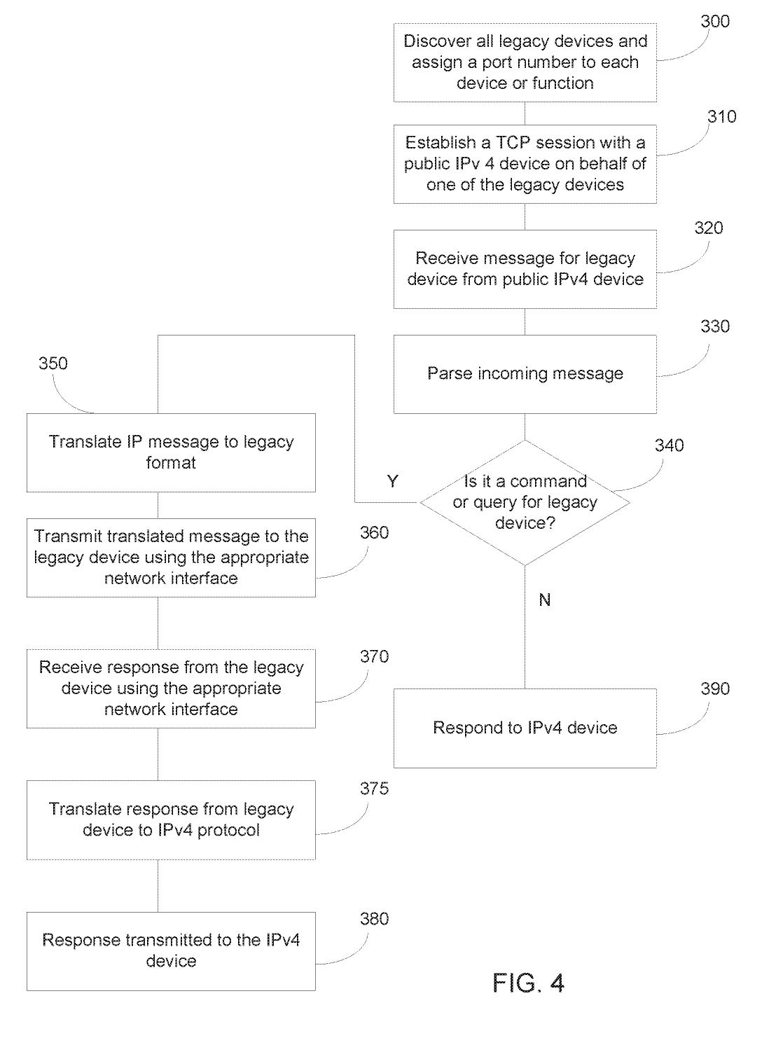

FIG. 4 shows a flowchart that demonstrates how the gateway device 10 can be used to establish and maintain a connection between a legacy device and an IPv4 device 1, such as a cloud server, a webserver, a DotDot device, or a mobile device.

First, as shown in Box 300 of FIG. 4 and described above, the gateway device 10 determines all of the legacy devices that are connected to the gateway device 10. It also creates a mapping of legacy device to port number. As described above, the gateway device 10 may assign port numbers based on device or based on function. Once this is completed, the gateway device 10 attempts to establish a TCP session with an IPv4 device 1 on behalf of one of the legacy devices, as shown in Box 310. This is accomplished by sending a message to the remote IPv4 device. At a later time, the remote IPv4 device 1 may send a message to the gateway device 10, as shown in Box 320. The gateway device 10 will parse the message, as shown in Box 330.

The gateway device 10 then checks to determine if the message is a command to or a query for the legacy device, as shown in Box 340. If it is, the gateway device 10 converts the command or query to the legacy format, as shown in Box 350. Certain legacy network protocols, such as ZIGBEE®, BlueTooth, and BLE use physical connections that are different from those present on the IPv4 network interface 30. In addition, these network protocols may utilize different network stacks than that used by the TCP/IP protocol. For those network protocols, the gateway device 10 needs to provide translation functionality, whereby the gateway device 10 converts packets from the IPv4 protocol, which are addressed to a particular port of the IP address in the gateway device 10, to a completely different network protocol. Thus, in the example shown above, any access to Ports 5700-5706 requires the gateway device 10 to translate the packet to a different protocol, having a different network layer and a different application layer.

Returning to FIG. 4, the gateway device 10 then transmits the legacy message to the legacy device as shown in Box 360. If the message is a query, the gateway device 10 receives a response from the legacy device, as shown in Box 370. It then translates this response to IPv4, as shown in Box 375. It then sends the response to the public IPv4 device 1, as shown in Box 380.

If the message is not a command or query for the legacy device, the gateway device 10 generates the proper response and replies to the public IPv4 device 1, as shown in Box 390. This may be performed without accessing the legacy device.

This system has the benefit of allowing existing devices to be used as the migration toward DotDot continues. Thus, rather than having to replace these legacy devices, gateway devices allow these devices to remain fully operational.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A gateway device, comprising:
a IPv4 network interface;
a secondary network interface;
a processing unit and a memory device, where the memory device comprises instructions, which when executed by the processing unit, allow the gateway device to:
receive a message from an IPv4 device using the IPv4 network interface;
translate the message to a legacy format; and
transmit the translated message using the secondary network interface to a legacy device, wherein the legacy device is determined based on a port number contained in the message received from the IPv4 device.

2. The gateway device of claim 1, wherein the secondary network interface supports a IEEE 802.15.4 network protocol.

3. The gateway device of claim 1, wherein the secondary network interface supports a BLUETOOTH® network protocol.

4. The gateway device of claim 1, wherein the memory device further comprises instructions, which when executed by the processing unit, allow the gateway device to:
communicate with legacy devices using the secondary network interface;
query each legacy device to understand functionality of each legacy device; and
enumerate each function as a port in an IPv4 address of the gateway device.

5. The gateway device of claim 1, wherein the memory device further comprises instructions, which when executed by the processing unit, allow the gateway device to:
communicate with legacy devices using the secondary network interface; and
enumerate each legacy device as a port in an IPv4 address of the gateway device.

6. The gateway device of claim 1, wherein the memory device further comprises instructions, which when executed by the processing unit, allow the gateway device to:
initiate a connection with the IPv4 device on behalf of the legacy device.

7. A method of configuring a legacy device to operate on an IPv4 network, comprising:
using a gateway device to communicate to the legacy device using a secondary network interface;
enumerating the legacy device as a port number on an IPv4 address of the gateway device; and
establishing a connection with an IPv4 device where a source address comprises the IPv4 address of the gateway device and the port number.

8. The method of claim 7, wherein the gateway device creates an internal mapping associating the port number with the legacy device.

9. The method of claim 7, further comprising:
querying the legacy device to understand functionality of the legacy device; and
wherein each function of the legacy device is assigned a unique port number.

10. The method of claim 7, further comprising configuring a second legacy device to operate on the IPv4 network by:
using a gateway device to communicate to the second legacy device using a second secondary network interface; and
assigning the second legacy device a second unique port number.

11. The method of claim 10, wherein the second secondary network interface is different than the secondary network interface.

12. The method of claim 10, wherein the secondary network interface utilizes a ZIGBEE® protocol.

13. The method of claim 12, wherein the second secondary network interface utilizes a BLUETOOTH® or Thread protocol.

14. The method of claim 7, wherein the IPv4 network comprises a DotDot network.

15. A gateway device, comprising:
a IPv4 network interface;
a secondary network interface;
a processing unit and a memory device, where the memory device comprises instructions, which when executed by the processing unit, allow the gateway device to:
communicate with a legacy device using the secondary network interface;
initiate a connection to a IPv4 device via the IPv4 network interface on behalf of the legacy device, wherein a source address used for the connection comprises a IPv4 address of the gateway device and a port number assigned to the legacy device by the gateway device.

16. The gateway device of claim 15, wherein the secondary network interface supports a IEEE 802.15.4 network protocol.

17. The gateway device of claim 15, wherein the secondary network interface supports a BLUETOOTH® network protocol.

18. The gateway device of claim 15, wherein the memory device further comprises instructions, which when executed by the processing unit, allow the gateway device to:
query the legacy device to understand functionality of the legacy device; and
enumerate each function of the legacy device as a port in the IPv4 address of the gateway device.

19. The gateway device of claim 15, wherein the memory device further comprises instructions, which when executed by the processing unit, allow the gateway device to:
communicate with additional legacy devices using the secondary network interface; and
enumerate each legacy device as a port in the IPv4 address of the gateway device.

20. The gateway device of claim 15, wherein the gateway device comprises a second secondary network interface, and the memory device further comprises instructions, which when executed by the processing unit, allow the gateway device to:
communicate with legacy devices using the second secondary network interface; and
enumerate each legacy device as a port in the IPv4 address of the gateway device.
